(19) United States
(12) Patent Application Publication
(10) Pub. No.: US 2009/0037201 A1
(43) Pub. Date: Feb. 5, 2009

(54) Care Provider Online Interview System and Method

(76) Inventor: Patrick Michael Cravens, Leesburg, VA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/832,798

(22) Filed: Aug. 2, 2007

(51) Int. Cl. G06Q 99/00

(52) U.S. Cl. 705/1

(57) ABSTRACT

Audio and video data associated with an answer to an interview question associated with care is received from a care provider. The audio and video data associated with the answer to the interview question is stored. At least a portion of the stored audio and video data is selectively output in response to a request for the audio and video data. In some embodiments, a portion of a profile of a care provider is output in response to a request. The profile includes audio and video data associated with answers by the care provider to a set of care-related interview questions. Information associated with a subscription to a care provider service is received. The entire profile of the care provider is output after receiving the information associated with the subscription.

### BACKGROUND

This invention relates to a system and method for screening and interviewing care providers and more particularly to an online interview and profile of a care provider.

Parents and guardians are very concerned about finding a qualified person to care for their children. Typically, the choice of a childcare provider is based on personal relationships or references. Absent some relationship or referral, parents are forced to utilize the service advertised by some childcare provider unknown to them. This situation can be exacerbated when traveling away from home and childcare provider services are required.

Pet and home owners have limited resources for finding people to care for their pets and homes. Typically, the choice of a pet care provider or a home care provider is also based on personal relationships or references. Limited selection of pet care and home care providers force pet and home owners to select potentially unskilled providers or providers with a lack of experience.

Resources to enable and assist parents, pet owners, and home owners in properly interviewing and screening care providers are non-existent and/or are time and cost prohibitive.

Moreover, care providers have limited resources and venues to advertise their care provider services. As a result, care providers often rely on word-of-mouth and referrals to generate new customers. The care provider is therefore limited in acquiring new potential employers or clients. Care provider placement services are lacking a controlled, subscriber-based environment where a subscriber may view a profile including video of the care provider answering pre-selected interview questions.

Thus, a need exists for a care provider profile and interviewing system that overcomes the limitations described above.

### SUMMARY OF THE INVENTION

Audio and video data associated with an answer to an interview question associated with care service is received from a care provider. The audio and video data associated with the answer to the interview question is stored. At least a portion of the stored audio and video data is selectively output in response to a request for the audio and video data.

In some embodiments, data associated with a profile of a care provider based on input from the care provider is stored. The profile includes audio and video data associated with answers by the care provider to a set of care-related interview questions. Data associated with at least a portion of the profile of the care provider is output through a user interface. The portion of the profile includes at least a portion of the audio and video data.

In some embodiments, a portion of a profile of a care provider is output in response to a request. The profile includes audio and video data associated with answers by the care provider to a set of care-related interview questions. Information associated with a subscription to a care provider service is received. The entire profile of the care provider is output after receiving the information associated with the subscription.

### BRIEF DESCRIPTION OF THE DRAWINGS

The invention is described with reference to the accompanying drawings.

FIG. 1 is a functional block diagram including a care provider system, according to an embodiment of the invention.

FIG. 2 is a flow chart illustrating a method of uploading and delivering care provider related data, according to an embodiment of the invention.

FIG. 3 is a flow chart illustrating a method of uploading and delivering care provider related data, according to an embodiment of the invention.

FIG. 4 is a flow chart illustrating a method of uploading and delivering care provider related data, according to an embodiment of the invention.

FIGS. 5-18 are examples of graphical user interfaces (GUIs) displayed during use of a system according to an embodiment of the invention.

### DETAILED DESCRIPTION

The care provider system and methods described herein can facilitate on-demand online screening and selection of a care provider, such as, for example, a babysitter, nanny, au-pair, pet walker, pet sitter, house sitter, tutor, eldercare provider, etc. The system and methods likewise enable a care provider to include a detailed profile, including a video interview for online viewing in a controlled, subscriber-based environment.

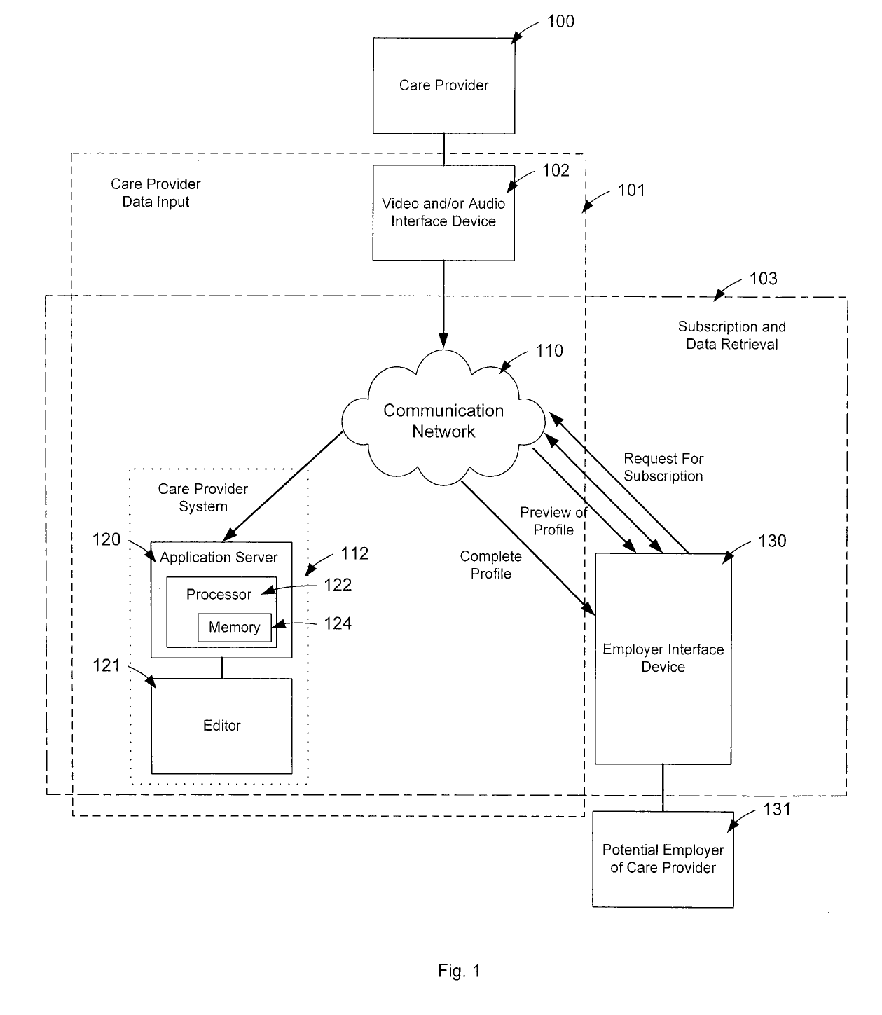

FIG. 1 is a functional block diagram including a care provider system 112 according to an embodiment of the invention. The care provider system 112 includes an application server 120 and an editor 121.

The systems and methods can be embodied in one or more hardware and/or software programs. The methods of the invention are described herein as being embodied in computer programs (software and/or hardware) having code to perform a variety of different functions associated with a care provider service program. It should be understood, however, that the methods are not limited to an electronic medium and can be alternatively practiced in a manual setting. All of the various methods described herein can upload and deliver care provider related data in a variety of different formats. For example, data associated with a care provider 100 can be in tabular format, graphical format, diagrammatical format, or chart format. The data associated with the care provider 100 can be transmitted via a network connection and/or via e-mail using the Internet.

The application server 120 according to an embodiment of the invention can be used to process data in accordance with the invention. Application server 120 includes a processor 122. The application server 120 can be accessible by the editor 121 and be in communication with one or more entities or devices (e.g., an employer interface device 130, a video interface device 102) via a broadband connection or other high-speed network. The processor 122 can be, for example, a commercially available personal computer, or a less complex computing or processing device that is dedicated to performing one or more specific tasks. For example, the processor 122 can be a terminal dedicated to providing an interactive graphical user interface (GUI). A GUI can also include accessories to provide audio output in addition to the visual output. The processor 122, according to one or more embodiments of the invention, can be a commercially available microprocessor. Alternatively, the processor 122 can be an application-specific integrated circuit (ASIC) or a combination of ASICs, which are designed to achieve one or more specific functions, or enable one or more specific devices or applications. In yet another embodiment, the processor 122 can be an analog or digital circuit, or a combination of multiple circuits.

The processor 122 can include a memory 124. The memory 124 can include one or more types of memory. For example, the memory 124 can include a read only memory (ROM) component and a random access memory (RAM) component. The memory 124 can also include other types of memory that are suitable for storing data in a form retrievable by the processor 122. For example, electronically programmable read only memory (EPROM), erasable electronically programmable read only memory (EEPROM), flash memory, as well as other suitable forms of memory can be included within the memory 124. The processor 122 can also include a variety of other components, such as for example, co-processors, graphic processors, etc., depending upon the desired functionality of the code.

The processor 122 is in communication with the memory 124, and can store data in the memory 124 or retrieve data previously stored in the memory 124. In other words, the memory 124 can be a processor-readable medium storing code representing instructions to cause the processor 122 to perform a process. The code can be any interpretable or executable code mechanism, such as, for example, interpretable programs, dynamic link libraries (DLLs), Java classes and applets, complete executable programs, Common Object Request Broker Architecture (CORBA) objects, and the like.

The components of the processor 122 can communicate with devices external to the processor 122 by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCSI) ports, and so forth. Additionally, the I/O component can include, for example, wireless connections, such as infrared ports, optical ports, Bluetooth® wireless ports, wireless LAN ports, or the like. The network to which the processor 122 is connected can be physically implemented on a wireless or wired network, on leased or dedicated lines, including a virtual private network (VPN).

In some embodiments, a system and method of the invention can be accessed and operated by the editor 121 via the application server 120, or alternatively by a third party.

A video and/or audio interface device 102 (herein referred to as the “video interface”) can be used by a care provider 100 to interface with the care provider system 112. Specifically, the care provider 100 can interface using the video interface 102 across a communication network 110 for various purposes (i.e., to send data to and receive data from the application server 120). The communication network 110 is coupled to the video interface 102 and the application server 120. The care provider 100 can be, for example, a babysitter, a nanny, an au-pair, a house sitter, a pet sitter, a pet walker, a tutor, an eldercare provider or any other individual intending to seek or provide personal care for homes, families, pets, or the like. The communication network 110 can include, for example, intranets, the Internet, and the like.

In one embodiment, the video interface 102 can be any known recording device capable of producing audio and video data associated with a video recording and capable of transmitting data over a network either directly or through a network interface device such as, for example, a computer. In some embodiments, the video interface 102 can produce the audio and video data when connected to an imaging device and/or an audio device. In some embodiments, the video interface 102 includes a personal computer coupled to a web camera and includes a microphone input. The video interface 102 can be, for example, a server as described above, an IP enabled appliance/device, a computer, a workstation, a thin-client, a personal digital assistant (PDA), a mobile communication device, or any other processor. The video data of the audio and video data can be produced by an imaging device, such as, for example, a video camera, a web camera, a charge coupled device (CCD), a complementary metal oxide semiconductor (CMOS) sensor, or the like. The audio data of the audio and video data can be produced by any known audio recording device, such as, for example, a microphone, an analog recorder, a digital recorder, etc.

The application server 120 can include a care provider data input software client or component located in the memory 124. The care provider data input software client can be configured to interface with the video interface 102 to produce the audio and video data as well as other data associated with the care provider 100. In one embodiment, the care provider data input software client is streamed from the application server 120 to the video interface 102 via the communication network 110. Specifically, at least a portion of the care provider data input software client is continuously sent by the application server 120 and received by the video interface 102. In some embodiments, the care provider data input software client is downloaded locally at the video interface 102 from the application server 120 via the communication network 110. In some embodiments, at least a first portion of the care provider data input software client is streamed from the application server 120 to the video interface 102 and at least a second portion of the care provider data input software client is downloaded locally at the video interface 102.

An employer interface device 130 can be accessible by a potential employer of the care provider 131. Specifically, the potential employer of the care provider 131 can interface with the employer interface device 130 across the communication network 110 for various purposes (e.g., to view a profile of a care provider, search for a care provider, etc.). The communication network 110 is coupled to the employer interface device 130 and, as stated above, to the application server 120. The potential employer of the care provider 131 as used herein can be defined as, for example, an individual who pays another individual for care-related services. The care-related services can be performed on a part-time or fulltime basis, on a regular or irregular basis, and/or for a specific task for a predetermined amount of time or an undetermined amount of time. The potential employer of the care provider 131 can be, for example, a parent, a guardian, a pet owner, a home owner, or any other individual intending to employ a care provider 100 for care of a home, family, pets, or the like. The employer interface device 130 can be any processor system configured to receive data and output visual and audible signals associated with the data. The employer interface system 130 includes a user interface, such as, a GUI. The employer interface system 130 can include for example, a server as described above, an IP enabled appliance/device, a computer, a workstation, a thin-client, a personal digital assistant (PDA), a mobile communication device, etc.

In some embodiments, the application server 120 includes a subscription and data retrieval software client or component located in the memory 124. The subscription and data retrieval software client is configured to provide subscriber level access by the employer interface device 130 to allow the display of audio and video data as well as the additional data associated with the care provider 100. In one embodiment, the subscription and data retrieval software is streamed from the application server 120 to the employer interface device 130 via the communication network 110. In some embodiments, the subscription and data retrieval software is downloaded locally on the employer interface device 130. In some embodiments, a combination of streaming and downloading of the subscription and data retrieval software can be utilized by the employer interface device 130.

Although streaming and downloading of software are described in detail, it should be understood that other care provider data input modalities and subscription and data retrieval modalities are possible, including for example, a compact disc storing software, or the like.

In use, a care provider data input process 101 is completed before a subscription and data retrieval process 103. The care provider data input process 101 includes producing the audio and video data using the video interface 102 and sending the audio and video data to the application server 120. The subscription and data retrieval process 103 includes sending information associated with a subscription from the employer interface device 130 to the application server 120. The subscription and data retrieval process also includes sending at least a portion of the audio and video data from the application server 120 to the employer interface device 130.

In some embodiments, the video interface 102 is configured to produce the audio and video data associated with one or more answers, provided by the care provider 100, to one or more interview questions associated with a related field of care. The video interface 102 can also be configured to facilitate production of the audio and video data. For example, the video interface 102 displays instructions to the care provider 100 regarding equipment setup and functional verification.

The interview questions for a childcare provider can include, for example, questions related to discipline style, experience with caring for children, babysitting training (e.g., first aid course, CPR course, etc.), use of spare time, hobbies, jobs, what the childcare provider likes best about babysitting, etc. The interview questions for a petcare provider can include, for example, questions related to experience caring for different types of pets, limitations on the types of pets for which the petcare provider willing to care, the number of pets for which the petcare provider is willing to care at a time, etc.

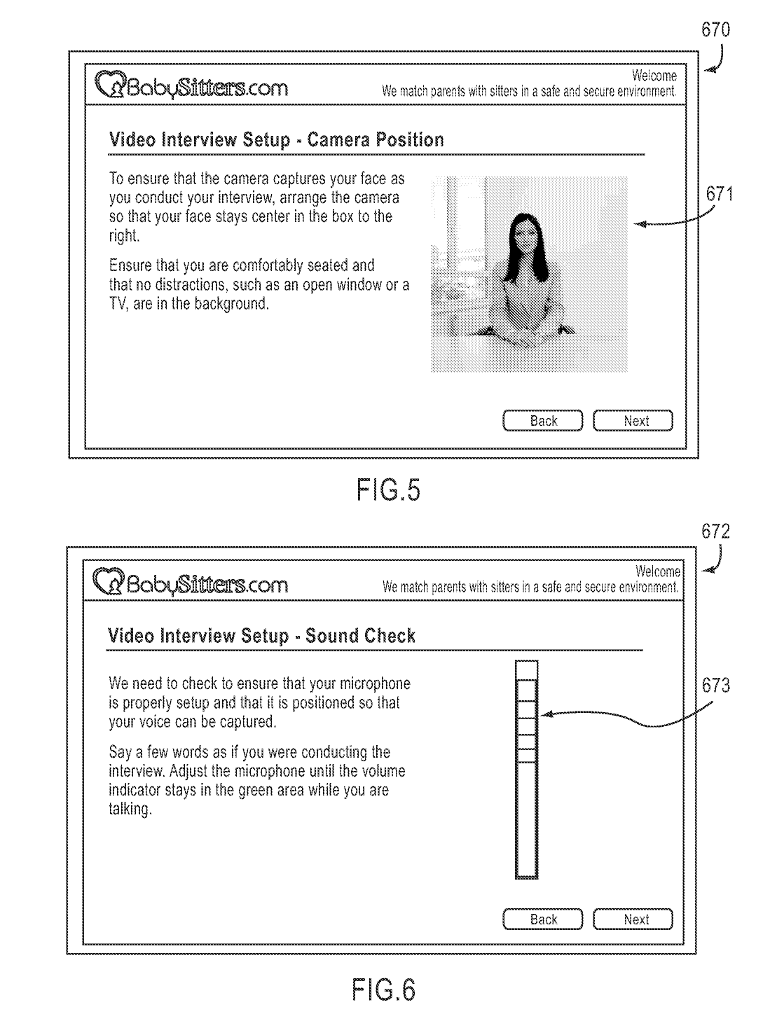

FIG. 5 shows an example of a camera setup GUI 670 that provides instructions to the care provider 100. The camera setup GUI 670 shows camera position for the video interview setup and allows the care provider 100 to adjust the camera focus, positioning and brightness settings prior to starting the interview process. In other words, an image 671 produced by the camera is displayed on the camera setup GUI 670 to assist the care provider 100 in adjusting the camera. Alternatively, the camera setup GUI 670 can display a template overlay to indicate where the head and face of the care provider 100 should be positioned with respect to the display.

FIG. 6 shows an example of an audio setup GUI 672 configured to facilitate audio setup and functional verification of audio equipment prior to starting the interview process. The audio setup GUI 672 helps the care provider 100 determine an appropriate volume level of the microphone. A volume level indicator 673 shows the volume level and can include ranges for too high, too low and within acceptable range.

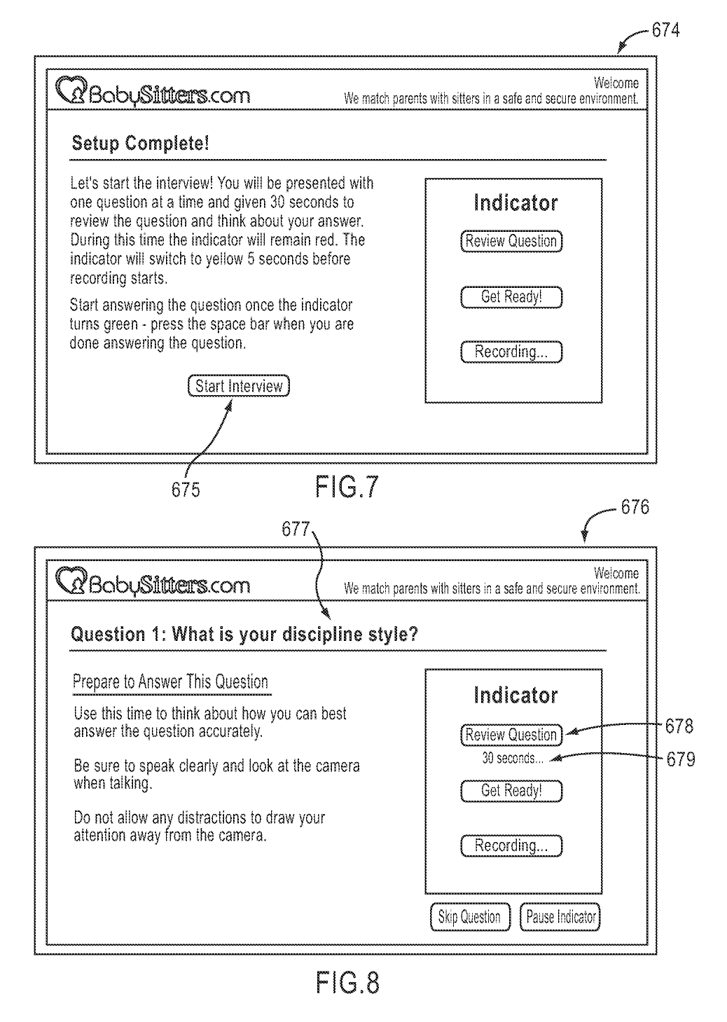

FIG. 7 shows an example of a setup complete GUI 674 including information associated with the interview and a start interview icon 675 configured to start the interview process.

In some embodiments, the care provider 100 can, at the video interface 102, select a user interface presentation style. For example, some user interfaces styles can be more casual while others more formal. In some embodiments, the care provider 100 can, at the video interface 102, select a display language for the interview questions.

The application server 120 is configured to output at least one interview question associated with a related field of care such that the video interface 102 can display the interview question to the care provider 100. In some embodiments, the server 120 outputs multiple questions or prompts that are output to the care provider 100. The video interface 102 is configured to enable the care provider 100 to produce the audio and video data associated with the answers to the interview questions associated with the related field of care. The related field of care can be, for example, childcare, petcare, homecare, and the like. The interview questions can be related to any situation specific to the care being sought or provided, such as, for example, experience of the care provider, training, full or part-time occupations, current living and family situations, transportation, the welfare of a child, pet care, home care, arrests, convictions, probation experience, visa status, green card status, immigration application status, cleaning standards, cooking experience, etc. FIG. 8 shows a GUI 676 including an interview question 677, for a childcare provider, related to discipline style.

The application server 120 is configured to output an indicia such that the indicia can be displayed to the care provider 100 at the video interface 102. In some embodiments, the indicia is associated with a countdown timer for preparing to receive the audio and video data. For example, with each interview question, the care provider 100 is presented with the text of the interview question 677 and a first indicia 678 (e.g., a red colored indicator) as shown in FIG. 8. The first indicia 678 indicates that the video interface 102 is not currently recording an answer to the interview question 677. In this example, the care provider 100 has “30 seconds” as indicated by a counter or timer 679 to review the interview question 677 and mentally formulate an answer before needing to verbally answer the interview question 677.

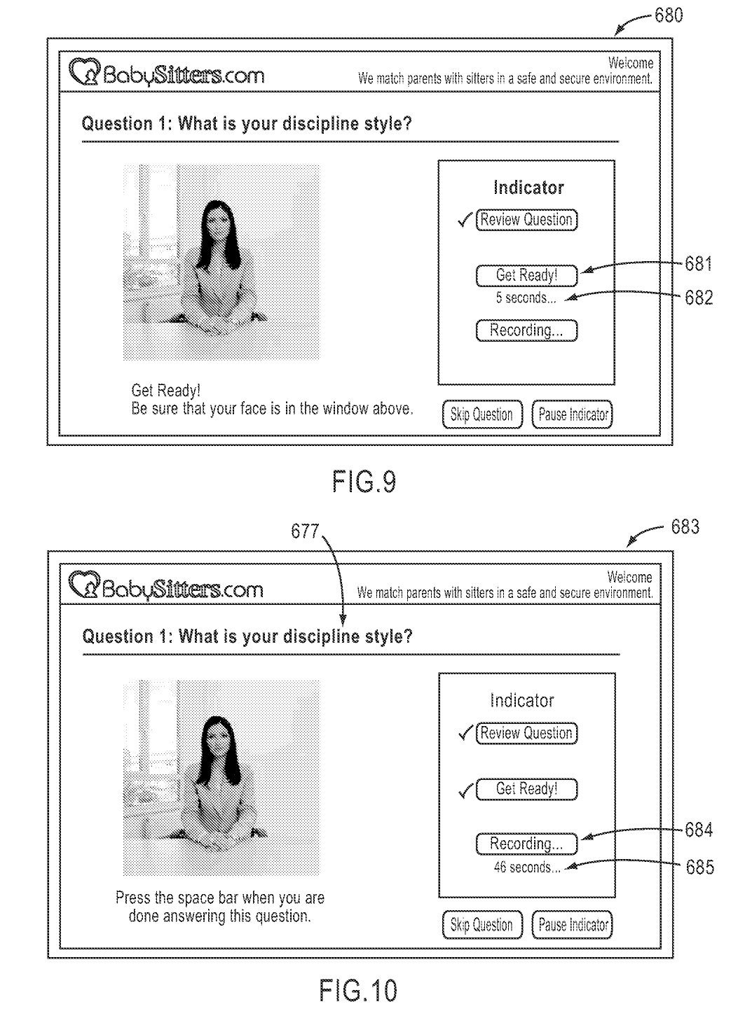

FIG. 9 shows an example of a GUI 680 showing a second indicia 681 (e.g., a yellow colored indicator) to indicate that the video interface 102 is not currently recording but will begin recording in a specified time frame, such as, for example, “5 seconds” as indicated by a timer 682 as shown in FIG. 9.

FIG. 10 shows a GUI 683 showing a third indicia 684 (e.g., a green colored indicator) to indicate that the video interface 102 is currently recording and that the care provider 100 should verbally answer the interview question 677 within the previously specified time frame. In some embodiments, the countdown timer 685 indicating the time remaining to complete the answer to the interview question 677 is also displayed.

In FIGS. 8-10, each indicia is shown and described as, for example, a colored labeled button, however, it should be understood that each indicia can be any of a variety of color indicators, including for example, a traffic light icon, a street sign (e.g., a stop sign), or the like.

The video interface 102 can include a GUI configured to permit the care provider 100 to start the recording, pause the recording, save the recording, submit the recording to the application server 120, etc.

FIG. 11 shows a GUI 686 including a re-record icon 687, review icon 688, end interview icon 689, and a next question icon 690. The care provider 100 can, for example, re-record an answer to the interview question 677 one or more times before submitting the audio and video data to the application server 120 for review by the editor 121.

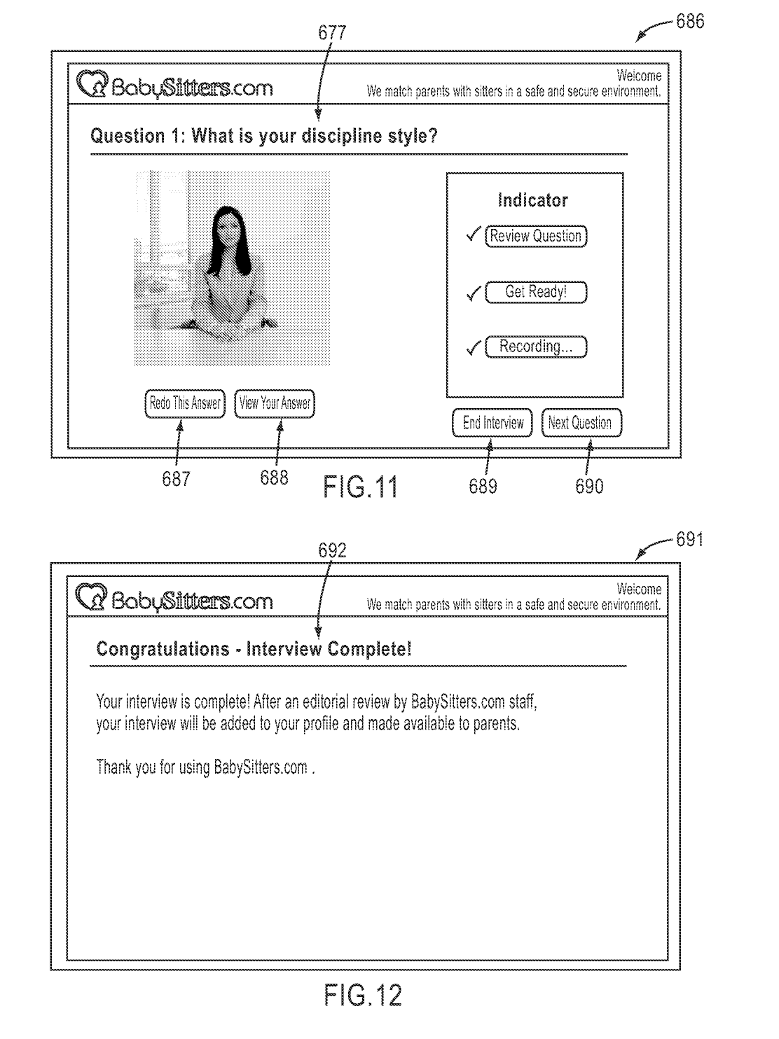

In some embodiments, a GUI 691 informing the care provider 100 when the interview has been successfully completed 692 and submitted for approval by an editor 121 can be displayed by the video interface 102 as shown in FIG. 12.

The application server 120 is configured to receive from a care provider 100 the audio and video data associated with answers to the interview questions associated with the related field of care. The application server 120 is configured to store data associated with a profile of the care provider 100 based on input from the care provider 100 to the memory 124. The profile includes the audio and video data associated with answers by the care provider 100 to the set of care-related interview questions. In some embodiments, the audio and video data is first stored in an editorial queue of the application server 120. Within this queue, the editor 121 can allow the recorded interview, in whole or in part, to be played. The editor 121 can also edit, rearrange, or delete at least a portion of the audio and video data. Said differently, an editor 121 can accept the interview as is, accept the interview as edited, reject the interview, or skip portions of the interview.

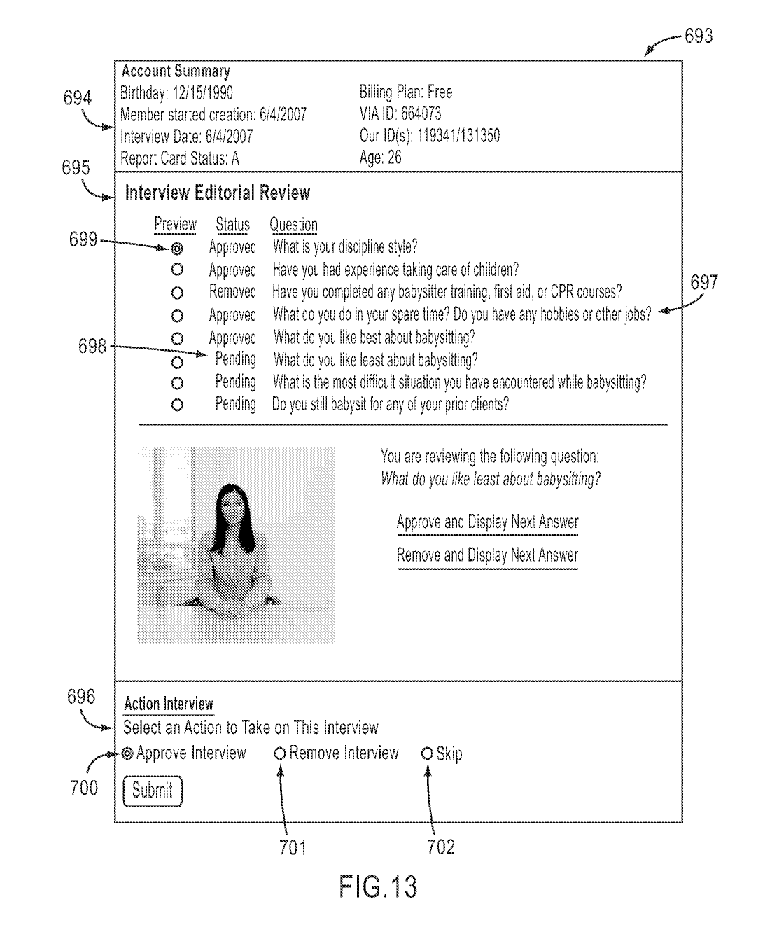

FIG. 13 shows an editor GUI 693 having an account summary portion 694, an interview editorial review portion 695 and an action interview portion 696. The account summary portion 694 includes general information about the care provider 100. The interview editorial review portion 695 includes previously recorded and submitted interview questions 697, an editorial status 698 of each interview question 697, a preview selection 699 that identifies the interview question 697 that will be available to the potential employer of the care provider 131 before obtaining a subscription to the care provider system 112. The action interview portion 696 includes an approve interview indicator 700, a remove interview indicator 701 and a skip interview indicator 702. In some embodiments, interview question 697 order different from the recorded order can also be adjusted by the editor 121.

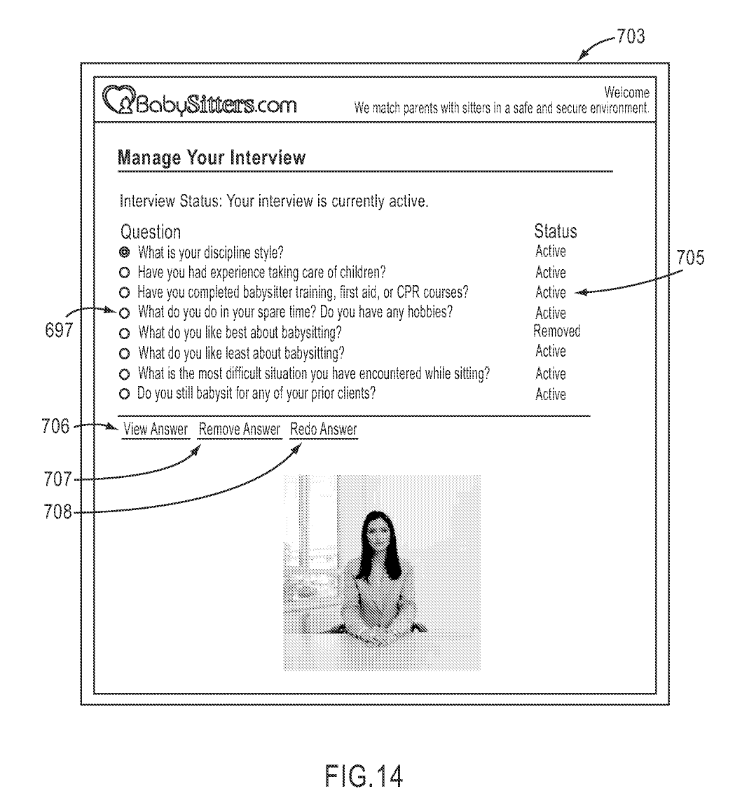

The application server 120 can receive edits and management instructions for the profile of the care provider 100 from the video interface 102. FIG. 14 shows a management GUI 703 showing interview questions 697 and the status 705 of each interview question 697. The management GUI 703 enables the care provider 100 to view an answer 706 to the interview question 697, remove the answer 707 and/or rerecord the answer 708.

In some embodiments, the profile includes characterization data associated with the care provider 100. The profile and associated characterization data is based, at least in part, on input from the care provider 100. The characterization data of the profile can include, for example, a location of the care provider 100, a geographic area in which the care provider 100 is available to provide care services, a reference for the care provider 100, an age of the care provider 100, a characterization rating of the care provider 100, a reference associated with the care provider 100, etc. For example, the profile of the care provider 100 can include a timetable associated with the availability of the care provider 100 to provide care services.

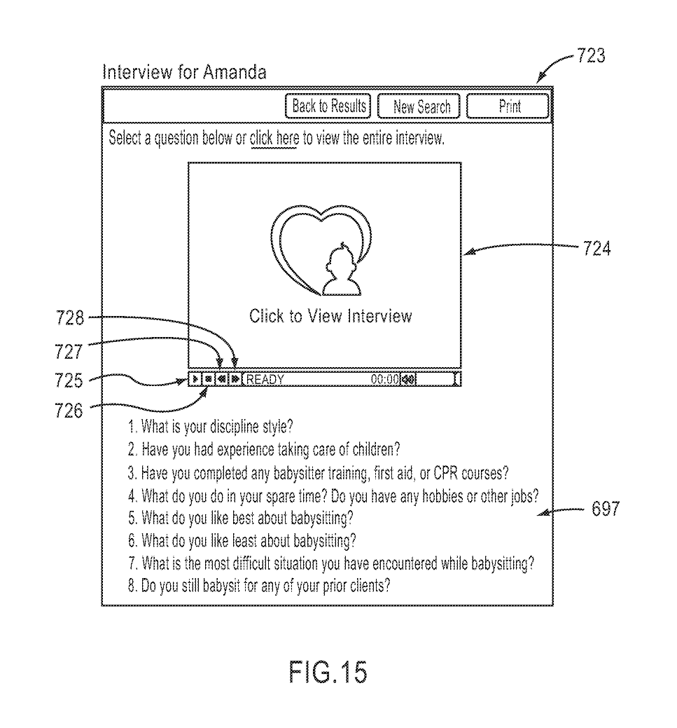

In one embodiment, the application server 120 is configured to selectively output data associated with at least the portion of the profile of the care provider 100 to the employer interface device 130 in response to a request to receive the portion of the profile. The portion of the profile is output such that the portion of the profile can be displayed on a GUI at the employer interface device 130. In some embodiments, profiles with a video interview can be marked or flagged in a search by the potential employer of the care provider 131. The application server 120 is configured to selectively output data associated with at least the portion of the profile in response to a user-specified search, a user browse, or via direct access. In some embodiments, the portion of the profile output includes at least a portion of the stored audio and video data such that the stored audio and video data can be displayed via a user interface. Said differently, the potential employer of care provider 131 can view the video responses of the care provider 100 to the care-related interview questions. FIG. 15 shows a media GUI 723 that includes a display 724 configured to output the audio and video data associated with the interview questions 697. The video display 724 includes icons to play the question 725, stop the playing of the question 726, fast-forward through the question 727 and rewind the question 728.

The application server 120 is configured to restrict access by the employer interface device 130 to the profile of the care provider 100 until a subscription to the care provider system 112 is obtained. Specifically, the application server 120 receives from the employer interface device 130 information associated with the subscription to a care provider service associated with the care provider system 112, including, for example, payment information associated with the potential employer of the care provider 131.

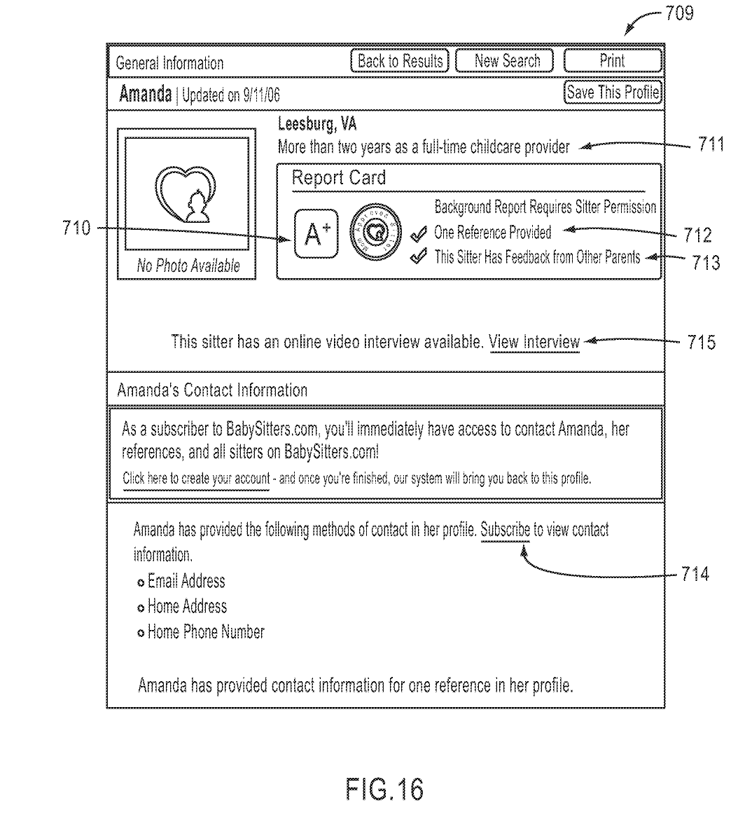

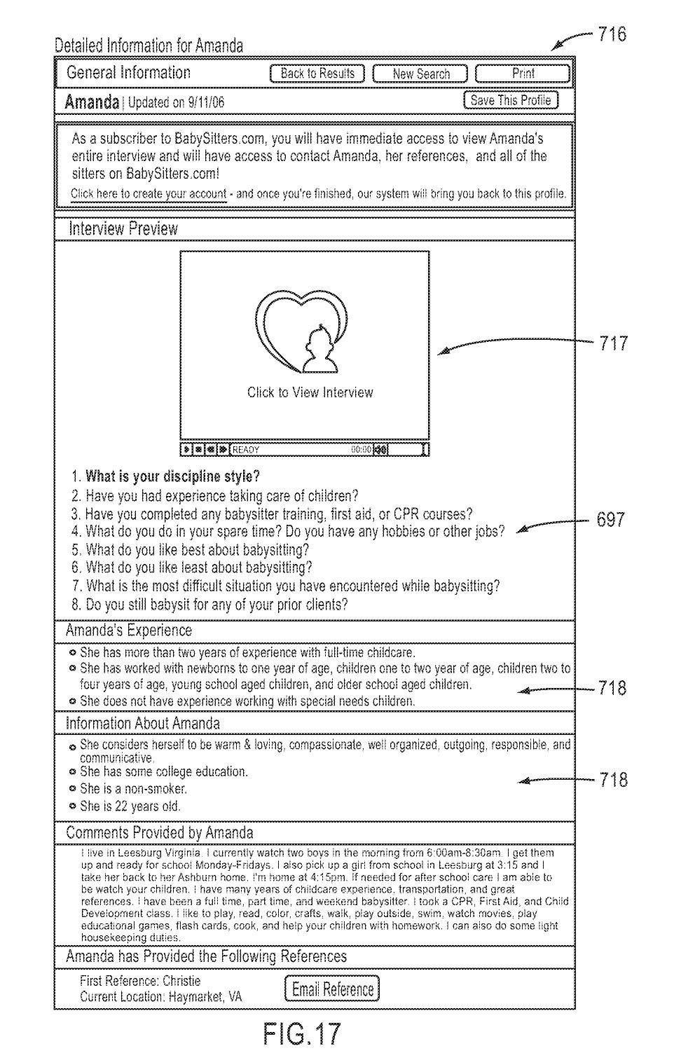

FIG. 16 shows an example of a GUI 709 of a preview portion of the profile of the care provider 100 that includes a characterization rating 710 and an amount of experience 711. The GUI 709 also includes options available to the potential employer of the care provider 131 once the subscription is obtained, such as, for example, a reference 712, feedback 713 from previous employers of the care provider 100, etc. In some embodiments, the GUI 709 does not include all of the options available to the potential employer of the care provider 131 once the subscription is obtained. For example, the profile of a particular care provider need not include any references or feedback from pervious employers. Additionally, the GUI 709 includes a subscription indicator 714 configured to enable the potential employer of the care provider 131 to obtain the subscription. In some embodiments, a view interview indicator 715 is configured to enable another GUI, such as for example, GUI 716 as shown in FIG. 17. The GUI 716 includes a preview portion 717 of the audio and video data associated with the answer to one or more of the interview questions 697. The GUI 716 also includes a portion 718 of the characterization data associated with the care provider 100.

The application server 120 is configured to output the entire profile of the care provider such that the entire profile can be displayed to the potential employer of the care provider 131 at the employer interface device 130 after receiving information associated with the subscription. In other words, the application server 120 is configured to output the entire stored audio and video data in response to receiving information associated with the subscription to the care provider service.

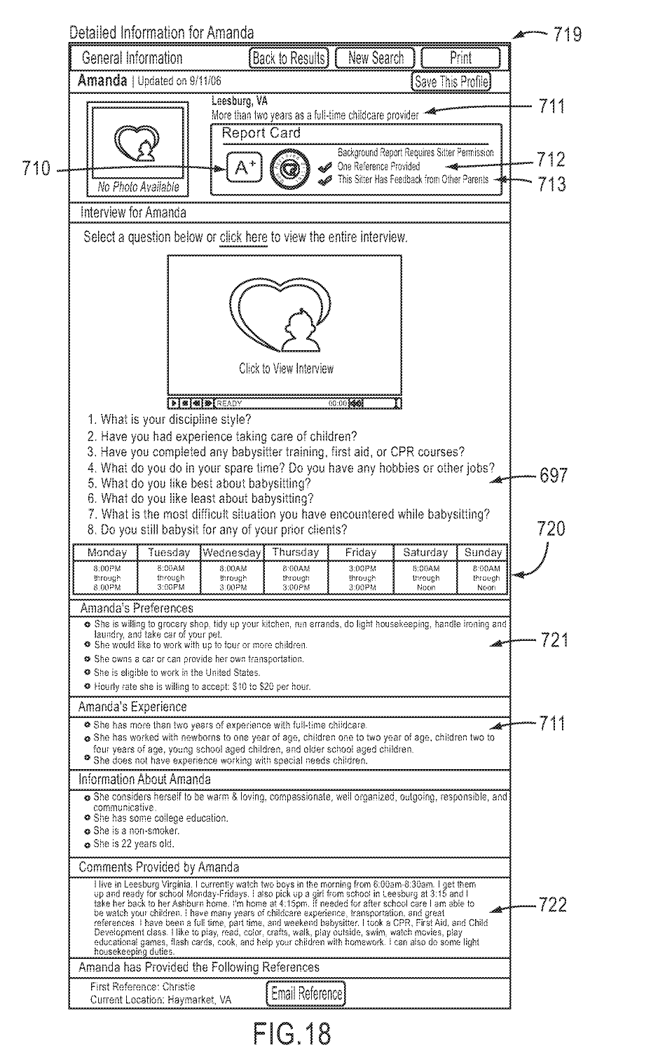

The selectively output information can include displaying the stored audio and video data on a display of the employer interface device 130. FIG. 18 shows an example of a GUI 719 of the entire profile that includes the entire stored audio and video data. In other words, each of the recorded answers to the interview questions 697 can be viewed by the potential employer of the care provider 131 via the employer interface device 130. The GUI 719 includes the characterization rating 710, the amount of care experience 711, the reference 712, the feedback 713 of previous employers, a timetable of availability 720, preferences 721 of the care provider 100, comments 722 by the care provider 100, etc. It should be understood that none of the above information, such as, for example, the reference 712, the feedback 713 from the previous employer, etc. is required to be displayed for the GUI 719 of the entire profile.

In the illustrated embodiment, the examples of various GUIs are shown with a specific configuration, presentation format and care service field. It should be understood, however, that each of the various GUIs described in detail can be any of a variety of different configurations, presentation formats and care-related fields. Additionally, the order of each of the GUIs can be changed.

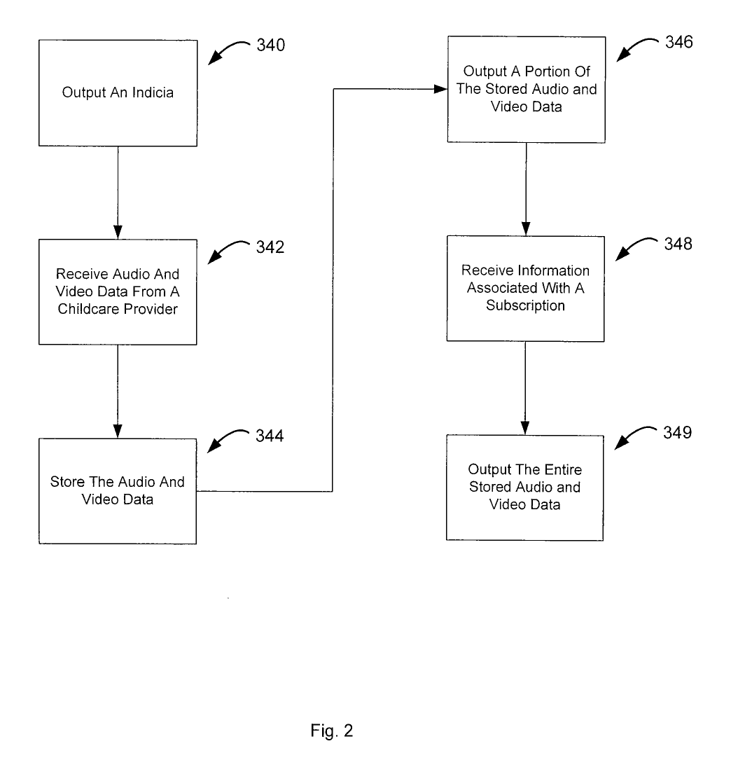

FIG. 2 is a flow chart illustrating a method, according to an embodiment of the invention. At 340, an indicia (e.g., a color indicia) is output to the care provider. The indicia is associated with a time for providing the audio and video data. At 342, audio and video data associated with an answer to an interview question associated with care services is received from the care provider. At 344, the audio and video data associated with the answer to the interview question is stored. At 346, at least a portion of the stored audio and video data is selectively output in response to a request for the audio and video data. At 348, information associated with a subscription to a care provider service is received from a user. At 349, the entire stored audio and video data is output after receiving information associated with the subscription to the care provider service.

In some embodiments, the stored audio and video data can be displayed on a GUI (e.g., as described above). In some embodiments, at least a portion of a profile of the care provider is output. The profile includes at least one of a location of the care provider, a geographic area in which the care provider is available to provide care services, a reference for the care provider, an age of the care provider, a characterization rating of the care provider, etc.

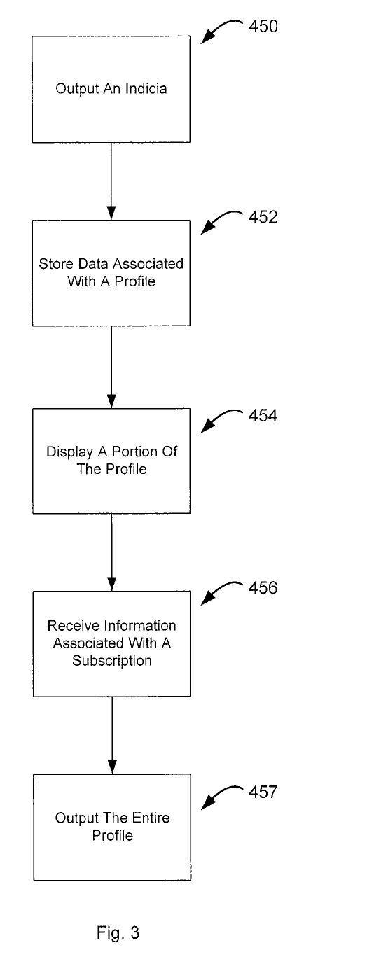

FIG. 3 is a flow chart illustrating a method according to an embodiment of the invention. At 450, an indicia associated with a time for receipt of answers by a care provider to a set of care-related interview questions is output. At 452, data associated with a profile of the care provider based on input from the care provider is stored. The profile includes audio and video data associated with answers by the care provider to the set of care-related interview questions. At 454, at least a portion of the profile of the care provider is displayed on a GUI. The portion of the profile includes at least a portion of the audio and video data. At 456, information associated with a subscription to a care provider service is received. At 457, the entire stored audio and video data is output in response to receiving the information associated with the subscription of the care provider service. In some embodiments, data associated with the entire profile of the care provider is output such that the entire profile can be displayed in response to receiving information associated with the subscription to the care provider service.

In some embodiments, the portion of the profile is displayed in response to a request to receive the portion of the profile. In some embodiments, the portion of the profile displayed is in response to a user-specified search. In some embodiments, the profile of the care provider includes a timetable associated with an availability of the care provider to provide care services. In some embodiments, the profile of the care provider includes at least one of a reference associated with the care provider, a location of the care provider, an age of the care provider, a characterization rating of the care provider, a geographic area in which the care provider is available to provide care-related services.

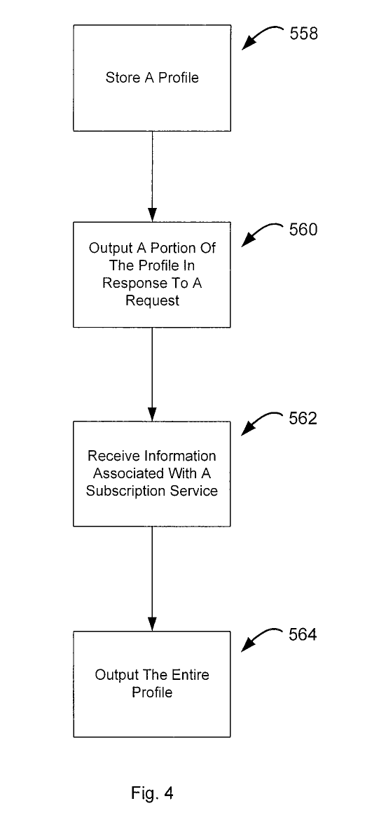

FIG. 4 is a flow chart illustrating a method according to an embodiment of the invention. At 558, a profile of a care provider is stored before a portion of the profile is output. At 560, the portion of the profile of the care provider is output in response to a request. The profile includes audio and video data associated with answers by the care provider to a set of care-related interview questions. At 562, information associated with a subscription to a care provider service is received. At 564, the entire profile of the care provider is outputted after receiving the information associated with the subscription.

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. The previous description of the embodiments is provided to enable any person skilled in the art to make and use the invention. While the invention has been particularly shown and described with reference to specific embodiments thereof, it will be understood that various changes in form and details may be made. For example, the care provider system can include various combinations and sub-combinations of the various embodiments described herein.

What is claimed is:

1. A processor-readable medium storing code representing instructions to cause a processor to perform a process, the code comprising code to:
receive from a care provider audio and video data associated with an answer to an interview question associated with care services;
store the audio and video data associated with the answer to the interview question; and
selectively output at least a portion of the stored audio and video data in response to a request for the audio and video data.

2. The processor-readable medium of claim 1, the code further comprising code to:
receive from a user information associated with a subscription to a care provider service; and
output the entire stored audio and video data after the code to receive information associated with the subscription to the care provider service.

3. The processor-readable medium of claim 1, wherein the code to selectively output at least the portion of the stored audio and video data includes code to output data configured to be output via a user interface.

4. The processor-readable medium of claim 1, the code further comprising code to output data associated with a display of an indicia to the care provider before the code to receive from the care provider, the indicia being associated with a time for providing the audio and video data.

5. The processor-readable medium of claim 1, the code further comprising code to output data associated with at least a portion of a profile of the care provider, the profile including at least one of a location of the care provider, a geographic area in which the care provider is available to provide care services, a reference for the care provider, an age of the care provider, a characterization rating of the care provider.

6. The processor readable medium of claim 1, wherein the care provider is at least one of a childcare provider, a pet-care provider, a home-care provider, a tutor, or an eldercare provider.

7. A processor-readable medium storing code representing instructions to cause a processor to perform a process, the code comprising code to:
store data associated with a profile of a care provider based on input from the care provider, the profile including audio and video data associated with answers by the care provider to a set of care-related interview questions; and
output data associated with at least a portion of the profile of the care provider through a user interface, the portion of the profile including at least a portion of the audio and video data.

8. The processor-readable medium of claim 7, wherein the code to output data associated with at least the portion of the profile of the care provider is in response to a request to receive the portion of the profile.

9. The processor-readable medium of claim 7, the code further comprising code to:
receive information associated with a subscription to a care provider service; and
output the entire stored audio and video data in response to receiving information associated with the subscription of the care provider service.

10. The processor-readable medium of claim 7, the coded further comprising code to:
receive information associated with a subscription to a care provider service; and
output via a user interface data associated with the entire profile of the care provider in response to receiving information associated with the subscription of the care provider service.

11. The processor-readable medium of claim 7, wherein the profile of the care provider includes a timetable associated with an availability of the care provider to provide care services.

12. The processor-readable medium of claim 7, wherein the code to output data is in response to a user-specified search.

13. The processor-readable medium of claim 7, wherein the profile of the care provider includes at least one of a reference associated with the care provider, a location of the care provider, an age of the care provider, a characterization rating of the care provider, a geographical area the care provider is available to provide care services.

14. The processor-readable medium of claim 7, the code further comprising code to output data associated with a display of an indicia associated with a time for receipt of the answers by the care provider to the set of care-related interview questions before the code to store data associated with the profile of the care provider.

15. The processor-readable medium of claim 7, wherein the care provider is at least one of a childcare provider, a pet-care provider, a home-care provider, a tutor, or an eldercare provider.

16. A processor-readable medium storing code representing instructions to cause the processor to perform a process, the code comprising code to:
output a portion of a profile of a care provider in response to a request, the profile including audio and video data associated with answers by the care provider to a set of care-related interview questions;
receive information associated with a subscription to a care provider service; and
after the code to receive the information associated with the subscription, output the entire profile of the care provider.

17. The processor-readable medium of claim 16, the code further comprising code to:
output data associated with a display of an indicia associated with a countdown timer indicating a time for preparing receipt of the audio and video data before the code to output the portion of the profile; and
receive audio and video data associated with the answers by the care provider to the set of care-related interview questions,
output the indicia associated with the countdown timer during the code to receive audio and video data.

18. The processor-readable medium of claim 16, the code further comprising code to store the profile of the care provider before the code to output the portion of the profile.

19. The processor-readable medium of claim 16 wherein the code to receive information associated with the subscription includes code to receive payment information.

20. The processor-readable medium of claim 16 wherein the profile includes at least one of a geographical area the care provider is available to provide care services, a reference for the care provider, a location of the care provider, an age of the care provider, a characterization rating of the care provider.

21. The processor-readable medium of claim 16, wherein the care provider is at least one of a childcare provider, a pet-care provider, a home-care provider, a tutor, or an eldercare provider.

22. A method, comprising:
receiving from a care provider audio and video data associated with an answer to an interview question associated with care services;
storing the audio and video data associated with the answer to the interview question; and
selectively outputting at least a portion of the stored audio and video data in response to a request for the audio and video data.

23. The method of claim 22, further comprising:
receiving from a user information associated with a subscription to a care provider service; and
outputting the entire stored audio and video data after receiving information associated with the subscription to the care provider service.

24. The method of claim 22, wherein the selectively outputting at least the portion of the stored audio and video data includes outputting data configured to be output through a user interface.

25. The method of claim 22, further comprising before the receiving from the care provider, outputting data associated with a display of an indicia to the care provider, the indicia being associated with a time for providing the audio and video data.

26. The method of claim 22, further comprising outputting data associated with at least a portion of a profile of the care provider, the profile including at least one of a location of the care provider, a geographic area in which the care provider is available to provide care services, a reference for the care provider, an age of the care provider, a characterization rating of the care provider.

27. The method of claim 22, wherein the care provider is at least one of a childcare provider, a pet-care provider, or a home-care provider.

28. A method, comprising:
storing data associated with a profile of a care provider based on input from the care provider, the profile including audio and video data associated with answers by the care provider to a set of care-related interview questions; and
outputting data associated with at least a portion of the profile of the care provider through a user interface, the portion of the profile including at least a portion of the audio and video data.

29. The method of claim 28, wherein the outputting data associated with at least the portion of the profile of the care provider is in response to a request to receive the portion of the profile.

30. The method of claim 28, further comprising:
receiving information associated with a subscription to a care provider service; and
outputting the entire stored audio and video data in response to the receiving information associated with the subscription of the care provider service.

31. The method of claim 28, further comprising:
receiving information associated with a subscription to a care provider service; and
outputting via a user interface data associated with the entire profile of the care provider in response to receiving information associated with the subscription of the care provider service.

32. The method of claim 28, wherein the profile of the care provider includes a timetable associated with an availability of the care provider to provide care services.

33. The method of claim 28, wherein the outputting data is in response to a user-specified search, a user browse, or a direct access.

34. The method of claim 28, wherein the profile of the care provider includes at least one of a reference associated with the care provider, a location of the care provider, an age of the care provider, a characterization rating of the care provider, a geographical area the care provider is available to provide care services.

35. The method of claim 28, further comprising before storing data associated with the profile of the care provider, outputting data associated with a display of an indicia associated with a time for receipt of the answers by the care provider to the set of care-related interview questions.

36. The method of claim 28, wherein the care provider is at least one of a childcare provider, a pet-care provider, a home-care provider, a tutor, or an eldercare provider.

37. A method, comprising:
outputting a portion of a profile of a care provider in response to a request, the profile including audio and video data associated with answers by the care provider to a set of care-related interview questions;
receiving information associated with a subscription to a care provider service; and
after receiving the information associated with the subscription, outputting the entire profile of the care provider.

38. The method of claim 37, further comprising:
before outputting the portion of the profile, outputting data associated with a display of an indicia associated with a countdown timer indicating a time for preparing receipt of the audio and video data; and
receiving audio and video data associated with the answers by the care provider to the set of care-related interview questions,
during the receiving audio and video data, outputting the indicia associated with the countdown timer.

39. The method of claim 37, further comprising before the outputting the portion of the profile, storing the profile of the care provider.

40. The method of claim 37 wherein the receiving information associated with the subscription includes receiving payment information.

41. The method of claim 37 wherein the profile includes at least one of a geographical area the care provider is available to provide care services, a reference for the care provider, a location of the care provider, an age of the care provider, a characterization rating of the care provider.

42. The method of claim 37, wherein the care provider is at least one of a childcare provider, a pet-care provider, a home-care provider, a tutor, or an eldercare provider.
